(19) United States
(12) Patent Application Publication
(10) Pub. No.: US 2019/0109865 A1
(43) Pub. Date: Apr. 11, 2019

(54) Pre-Crime Method and System for Predictable Defense Against Hacker Attacks

(71) Applicant: Peter Kämper, Bernau am Chiemsee (DE)

(72) Inventor: Peter Kämper, Bernau am Chiemsee (DE)

(21) Appl. No.: 15/761,005

(22) PCT Filed: Sep. 19, 2016
(86) PCT No.: PCT/EP2016/072135

§ 371 Date: Mar. 16, 2018

(30) Foreign Application Priority Data
Sep. 17, 2015 (DE) 10 2015 115 672.5

(51) Int. Cl. H04L 29/06

(52) U.S. Cl. CPC H04L 63/1416; H04L 63/145; H04L 63/1458

(57) ABSTRACT

A pre-crime method and system for predictable defense against attacks on an information network. The method comprises the steps of detecting current events, comparing the detected current events with historical incidents stored in a database, requesting historical attack characteristics after determining matches between the detected current events and the historical incidents, and activating defense measures in the information network based on the historical attack characteristics.

### BACKGROUND OF INVENTION

### Field of Invention

The present invention relates to a method and system for predictably defending against hacking or cyber attacks.

### Brief Description of the Related Art

In March 2014 the Ukrainian Prime Minister visited the German Federal Government in Berlin. On the same day, many servers run by the German government were attacked from Russia. Many of the attacked computers were not reachable during the whole day.

Taking this into account, a renewed attack under similar conditions is likely. Should the Ukrainian Prime Minister again travel to Berlin and the state of emergency between Russia and the Ukraine further persist, one can assume that there will be possibly even greater attacks against the servers of the Federal Government. Thus, it would be advantageous to detect when, how and where a hacking attack could take place.

Corresponding protective or defensive measures can therefore be put in place already or long before a similar event, and even if required still can be tested. In the literature the term “pre-crime” is used to designate a method for the detection of such predictable occurrences.

### SUMMARY OF THE INVENTION

The aim of the present invention is to predict the defense of hacker attacks using an information network and so to improve this defense. This object is carried out by incorporating knowledge about what is happening in politics, world business, war, terror and anti-terrorism measures associated with old and new possible attacks to introduce and optionally adapt the protection and defensive systems in such a way to avert thus an attack on the information network.

By the observations, the time point of a potential hacker attack is determined and for the period of the expected hacker attack, an increased level of IT security and defensive measures are implemented, which, in the normal daily schedule possibly could not or must not be implemented. In this way, also protective measures prior to hacker attack itself are initiated. For example, the system can control firewalls or burglary protection systems for increasing the security level of the information network.

The system and the method also permit post-processing of a hacker attack. A database is populated from the experiences of the attacks in the system and evaluated in order to learn from the attacks and also prepare the system for new possible attack types and scenarios. Thus, the experience and reaction possibilities of the system grow with each occurrence and new knowledge

The system also transmits early warnings to the customer and or to the general public. Should one of the customers not desire an automated increase in the level of IT security requirements, manual protection systems are prepared by means of the warnings.

The invention achieves the following: increasing the IT security, increasing the sensitivity, increasing the preparation time to attack, increasing the chances of a defense against an attack and increasing the tools in the fight against cyber terror and cyber attacks.

### BRIEF DESCRIPTION OF THE DRAWINGS

The invention will now be explained on the basis of the drawings.

FIG. 1 is an overview of the system,

FIG. 2 is a process flow illustrating the method of the present invention.

### DETAILED DESCRIPTION OF THE INVENTION

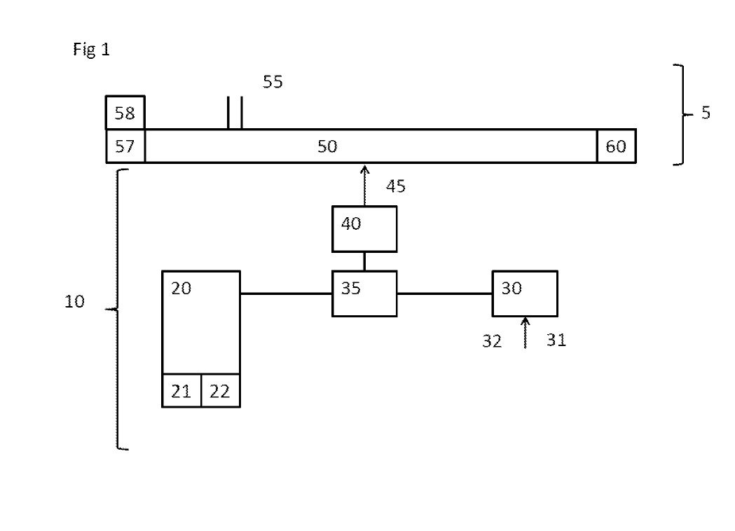

FIG. 1 shows an overview of the system. The system 10 monitors an information network 5 and comprises one or more databases 20, which store knowledge of hacker attacks and protection and defensive measures. A detection unit 30 receives regular indications 31 of current events, for example from politics, and compares these in a comparator unit 35 with events in the database 20 comprising stored knowledge of historical events 21, in order to detect similarities. An output unit 40 sends messages 45 about possible hacker attacks and countermeasures to the general public and also to connected systems 50. The connected systems 50 have protective devices 60, which are switched on, upon detection of a risk situation for example a hacker attack.

The database 20 learns from experience. The input unit 30 evaluates the received events 31 and links these received events 31 with information 32 about events, such as hacker attacks. These events 31 are stored, together with the indications 32 about the associated occurrences in the database 20. Thus, the system 10 learns when, where and how it will be could be attacked. In such a way, the systems 50, which are connected to the system via the output unit 40, can be protected and attacks can be repulsed.

In the detection unit 30 are the non-technical background data initially entered manually into the database 20 and evaluated. In the example noted above, for example the parameters Attack, Russia, Ukraine War etc. must be stored and are evaluated. An analysis can be carried out each time, even with newer parameters and data structures. From the experience during the visit of the Ukrainian Prime Minister, the details of the occurrences are entered in the database 20.

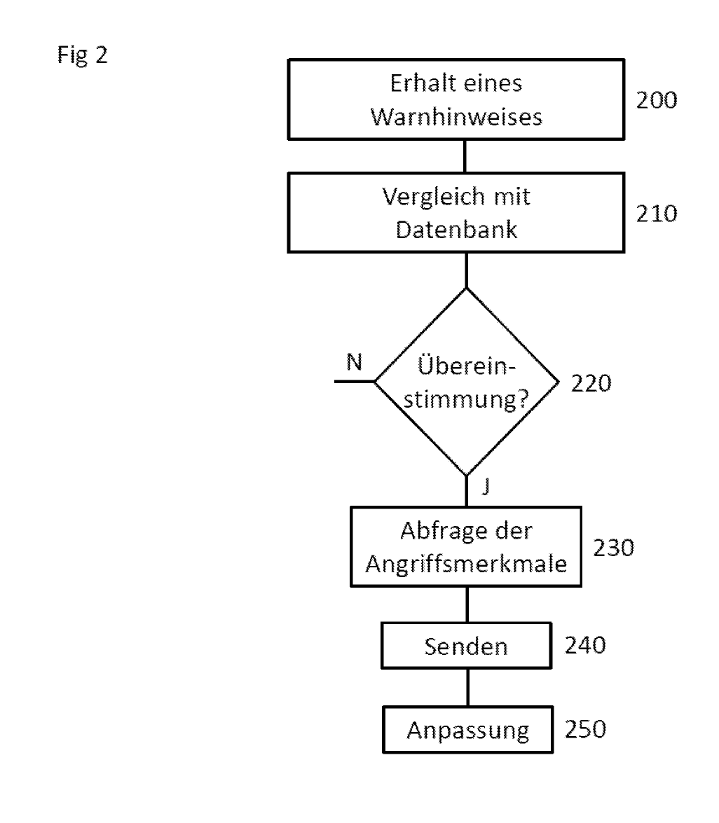

FIG. 2 show the steps of the defensive method. The method starts in step 200 upon detection of a warning message in the form of a relevant current event 31 to the input unit 30. This warning message can be generated from regular database queries automatically, by a manual input or by a trigger. For example, the visit of a foreign politician to Berlin would generate a series of measures which can include also the warning indication to the future event 31. Alternatively, a regularly performed query in a news database, such as Reuters or DPA, outputs also corresponding warning notices. In other cases, the official safety emergency plans be changed such a way so that said plans also initiate the pre-crime method and the defensive measures.

The input unit 30 evaluates in the step 210 the warning indications 60 and searches for corresponding, already stored similar historical events 21. Should in step 220 a match or at least a partial match be detected in the database 20, engagement features 22 are in step 230 retrieved from the database for the corresponding occurrence 21 in step 230. The output unit 30 transmits in step 240 a message 45 with the read-out engagement features 22 to the connected systems 50, thus the protection of the connected systems 60 is enabled manually or in an automated manner in step 250. To this end, the engagement features taken into account. Thus, for example, for the period of the expected attack, maintenance accesses 55 to the connected systems 50 are deactivated by the protection device 60, since the maintenance accesses 55 are known as possible source for a hacker attack and also in the past have been attacked. External employees using the maintenance accesses 55 can only one day later synchronize their data. In another scenario the web server 57 allows no login or more processing.

In a so-called DoS (denial-of-service) attack a buffer can be used before enabling an access of one or more of the connected systems 60. This buffer memory collects firstly all the incoming data or messages and allows only the desired messages through. According to another aspect of the system, the connected system can be “replicated”, thus providing the connected system with sufficient processor capacity, in order to process all incoming data. Thereby an attack to turn off the system by over-occupancy of the processor capacity is defeated.

Other possible protective measures include, inter alia, the switching off of an email server 58.

The protective device 60 can switch the defensive measures on only for a limited time or permanently.

The detection unit 30 correlates events from politics, society, business, sport, war/disturbances, church, terror attacks and a plurality of further events at the level of IT security (current attacks, viruses, spam, trojans, old attacks, etc. . . . ). Reports about such occurrences are distributed on web pages, such as that of the Heise publishing house, Gateprotect, IT security news, BSI, international, etc., from where they can be analyzed.

For the “filling” of the database 20, there are both manual and automated methods. The manual method is very precise, has a reduced error rate, but also a very high personnel requirements. All events are stored which correspond to the example “Visit Ukraine Berlin”. Alternative methods for filling of the data-bank 20 are, inter alia, interrogation programs, engagement post-preparation, press system and by text and web mining systems.

Furthermore, a plurality of organizations can work together on said system 10 and carry out common data curation. For example, several security agencies can operate together one of the systems 10 and “fill” it, but each of the security agency maintains its own evaluations and activation of protection and defensive measures.

The evaluations in the output unit 40 take place by means of its own scripts and programs, or data query programs or data mining or data mining systems.

For the interrogation configuration different markets or interests are to be taken into account. The Federal Government, or their IT suppliers, are interested in the next Ukraine

Berlin visit, whereas an enterprise such as Audi or Mercedes is not actually interested therein. In other words, when a central system should serve a plurality of markets or companies, the input unit and the comparison unit 35 must be operated individually.

The system 10 can not only manage hacking attacks, but also provide further information from the level of IT security. The most recent virus types and attack patterns are populated as well as the propagation of viruses or spam, trojans or other harmful software.

When a virus from, for example Russia, spreads out in the direction of Europe then the systems 10 in the Europe already have knowledge of before the worm/trojan or virus reaches the system 10. This relates to all IT security or safety-relevant systems and pests, whether these are a virus, a trojan, a worm, on-line banking fraud, smartphone hacking, phishing or other risks. The system 10 manages all hacks and hacking attack in cooperation with the non-technical data and protects their systems.

Firewall data will be extracted from the log file, the security system or the intrusion detection system and also transmitted to the input unit 20 for the purpose of further evaluation and growth. There is a two-way exchange of information between the central station and the decentralized systems which are to be controlled. Knowing the transmission of the firewall data means that abnormalities in the existing connections in the firewall can be passed to the system 10 for further processing.

The system 10 also obtains information from the IDS (intrusion detection system) manufacturers. An IDS operates on the basis of “comparison patterns”. The comparison patterns are, as in the case of the viral scanners, passed from the manufacturer to the customers. The system 10 stores not only the pattern from, but knows also the propagation, and thus draws conclusions about the origin of attack or virus. Thus, the system can likewise incorporate geographical situations and danger situations. This makes it possible to construct degrees of danger for individual countries, regions or political situations.

The required queries are defined in the comparison unit 35, which is designed in the form of a data mining system.

To this end, the links are created from the data interrogation with customer and target date.

The system 10 can inter alia be used by an insurance company. The insurance companies can write the policies for internet crime such that knowledge about new or recurring attacks already are taken into account.

The system can also improve the security of the authorities and large customers.

With the aid of the system 10, the technical expenditure for the care of the system 10 and thus costs are reduced in server farms.

1. A method for defense of attacks against on information network comprising:
detecting of current events;
comparing the detected current events with an historical event journal stored in a database;
obtaining historical attack characteristics based on matches of detected current events with historical events;
initiating defensive measures in the information network based on the historical attack characteristics.

2. A method according to claim 1, where the current events are one of events of political nature, societal nature or economic nature.

3. The method according to claim 1, further comprising;
monitoring the information network for further attack attempts.

4. The method according to claim 3, comprising storage of attack attempts in the database.

5. The method according to claim 1, where the historical attack characteristics are at least one of viruses, firewall attacks and denial of service.

6. The method according to claim 1, further comprising sending messages about the initiating of defensive measures.

7. A system for the defense of attacks on an information network comprising:
a database to store relationships between historical events and historical attack characteristics;
a detection unit for detection of current events;
a comparison unit for comparing the current events with the historical events;
an output for sending messages via defensive measures according to the comparison of the detected current events with the historical events.

8. According to claim 7 further comprising a protective device for initiating one or more defensive measures.

9. The system according to claim 7, wherein the current events are at least one of political, social or economic in nature.

10. The system according to claims 7, further comprising;
an attack monitoring engine.

11. The system according to claim 7, wherein the database comprises a plurality of relationships between the historical events and defensive measures.

12. A system according to claim 7, wherein the attack characteristics are at least one of viruses, firewall attacks and denial of service.

13. (canceled)

14. (canceled)
